(19) United States
(12) Patent Application Publication
(10) Pub. No.: US 2020/0380615 A1
(43) Pub. Date: Dec. 3, 2020

(54) CONTEXTUAL MOBILITY TAGGING FOR CONTACTS IN ELECTRONIC COMMUNICATIONS

(71) Applicant: INTERNATIONAL BUSINESS MACHINES CORPORATION, Armonk, NY (US)

(72) Inventors: Michael Bender, Rye Brook, NY (US); Sarbajit K. Rakshit, Kolkata (IN); Jeremy R. Fox, Georgetown, TX (US); Craig M. Trim, Ventura, CA (US)

(21) Appl. No.: 16/428,284

(22) Filed: May 31, 2019

(51) Int. Cl. G06Q 50/00; G06F 16/45; G06F 16/487; G06F 16/48; G06F 16/435; G06F 16/9032

(52) U.S. Cl. CPC G06Q 50/01; G06F 16/45; G06F 16/90324; G06F 16/489; G06F 16/436; G06F 16/487

(57) ABSTRACT

A computer-implemented method for tagging one or more users and one or more contextual categories of an electronic communication. The computer-implemented method identifies one or more users in an electronic communication, one or more activities associated with the electronic communication, and metadata containing location and time information for content in the electronic communication, in response to receiving the content from a user. The computer-implemented method further maps the identified one or more users in the electronic communication with the one or more activities associated with the electronic communication, and generates one or more tagging suggestions for the electronic communication, based on the mapping. The computer-implemented method further posts the electronic communication with the generated one or more tagging suggestions.

### BACKGROUND

The present disclosure relates generally to the field of cognitive computing, Internet of Things (IoT), and more particularly to data processing and contextual mobility tagging for contacts in electronic communications, such as an electronic forum or a social media website.

Social media networks allow friends and family to share various kinds of information, both about the poster and those that may be referenced, or tagged, in the social media post. For example, a poster (e.g., user) may post a synopsis about their month long trip overseas and tag various individuals (e.g., contacts or “friends”) in their post. A viewer of the post has no way of knowing, for example, which of the tagged individuals actually accompanied the user on his rafting trip, celebrated his birthday dinner at the beach bonfire, or participated in the street carnival.

Social media platforms enable users to tag individuals in social media posts, usually with the name of the user that is registered with the social media platform. However, individuals oftentimes have various names depending on the context they find themselves in at the moment. For example, a user may be called “Daddy” around his children, “Mr. Jones” around his colleagues, “Scott” around his family, and “Scotto” around his friends.

### BRIEF SUMMARY

Embodiments of the present invention disclose a method, a computer program product, and a system.

According to an embodiment, a method, in a data processing system including a processor and a memory, for implementing a program. The method identifies one or more users in an electronic communication, one or more activities associated with the electronic communication, and metadata containing location and time information for content in the electronic communication, in response to receiving the content from a user. The method further maps the identified one or more users in the electronic communication with the one or more activities associated with the electronic communication, and generates one or more tagging suggestions for the electronic communication, based on the mapping. The method further posts the electronic communication with the generated one or more tagging suggestions.

According to another embodiment, a computer program product for directing a computer processor to implement a program. The storage device embodies program code that is executable by a processor of a computer to perform a method. The method identifies one or more users in an electronic communication, one or more activities associated with the electronic communication, and metadata containing location and time information for content in the electronic communication, in response to receiving the content from a user. The method further maps the identified one or more users in the electronic communication with the one or more activities associated with the electronic communication, and generates one or more tagging suggestions for the electronic communication, based on the mapping. The method further posts the electronic communication with the generated one or more tagging suggestions.

According to another embodiment, a system for implementing a program that manages a device, includes one or more computer devices each having one or more processors and one or more tangible storage devices. The one or more storage devices embody a program. The program has a set of program instructions for execution by the one or more processors. The program instructions include instructions for identifying one or more users in an electronic communication, one or more activities associated with the electronic communication, and metadata containing location and time information for content in the electronic communication, in response to receiving the content from a user. The program instructions further include instructions for mapping the identified one or more users in the electronic communication with the one or more activities associated with the electronic communication, and generating one or more tagging suggestions for the electronic communication, based on the mapping. The program instructions further include instructions for posting the electronic communication with the generated one or more tagging suggestions.

### BRIEF DESCRIPTION OF THE DRAWINGS

FIG. 1 illustrates a name and context tagging computing environment, in accordance with an embodiment of the present invention.

FIG. 2 is a flowchart illustrating the operation of the name and context tagging system of FIG. 1, in accordance with an embodiment of the present invention.

FIG. 3 is a diagram graphically illustrating the hardware components of a computing environment of FIG. 1, in accordance with an embodiment of the present invention.

FIG. 4 depicts a cloud computing environment, in accordance with an embodiment of the present invention.

FIG. 5 depicts abstraction model layers of the illustrative cloud computing environment of FIG. 4, in accordance with an embodiment of the present invention.

### DETAILED DESCRIPTION

Tagging a friend, and being tagged in return, in electronic communications (e.g., on social media websites, or an electronic forum) is commonplace. Quite often, the proposed suitable tag for an identified individual is the name of a person spotted in an image, using computer vision techniques. One challenge that has not yet been solved is knowing the best variation, or form, of an identified individual's name to use for the tag.

For example, many people have various names (e.g., nicknames, formal names, etc.) that are used in different contexts. Some nicknames belong exclusively to a group of friends or a set of acquaintances in a particular circle and would not be suitable for widespread use. Using a formal name, or nickname, in the wrong context may be inappropriate or embarrassing.

In addition to tagging an individual with the best-suitable name in the appropriate context of an electronic communication, another problem that has not been solved is arranging the context-based tag of the one or more identified individuals in the post based on the activity that is occurring, or has occurred. For example, the context of the tagged individuals that are travelling together, the tagged individual(s) that came to the airport to see them off, the tagged individuals who joined the going away party the night before, etc. By creating contextual tagging of identified individuals within a social media post, for example, other social network users that are in the poster's network can understand the purpose of tagging multiple “friends” within one post.

Throughout the present disclosure, reference to a social media post is not limiting but rather may further include any electronic communication. An electronic communication herein may include a social media website post, an electronic forum post, electronic mail, or any other electronic communication known to one of ordinary skill in the art.

In exemplary embodiments, an individual, or group, may be tagged in an electronic communication. The individual, or group, may be tagged with a name, context, or any other category known to one of ordinary skill in the art.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

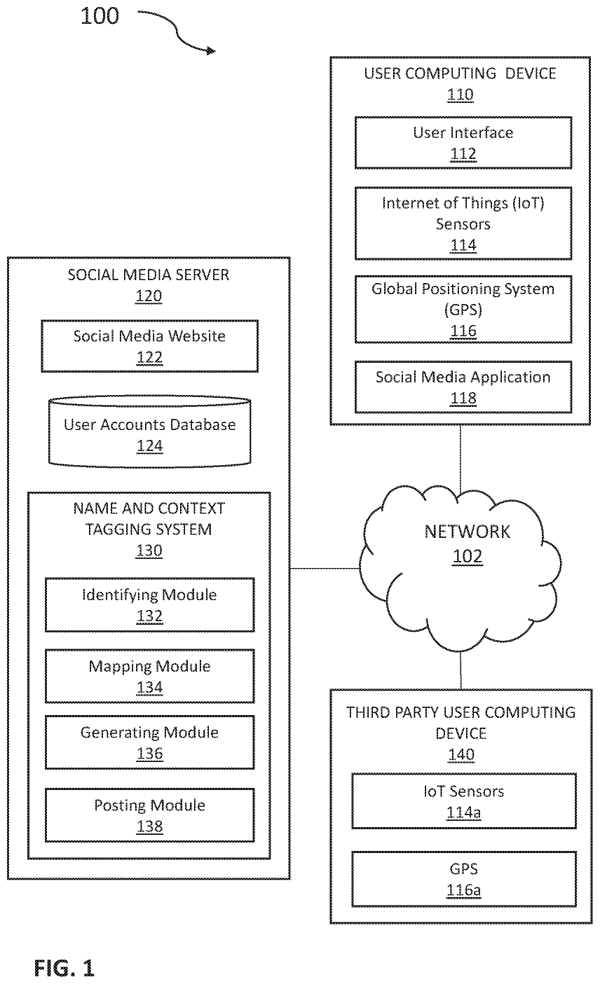

FIG. 1 illustrates name and context tagging computing environment 100, in accordance with an embodiment of the present invention. Name and context tagging computing environment 100 includes user computing device 110, social media server 120, and third party user computing device 140, all connected via network 102. The setup in FIG. 1 represents an example embodiment configuration for the present invention, and is not limited to the depicted setup in order to derive benefit from the present invention.

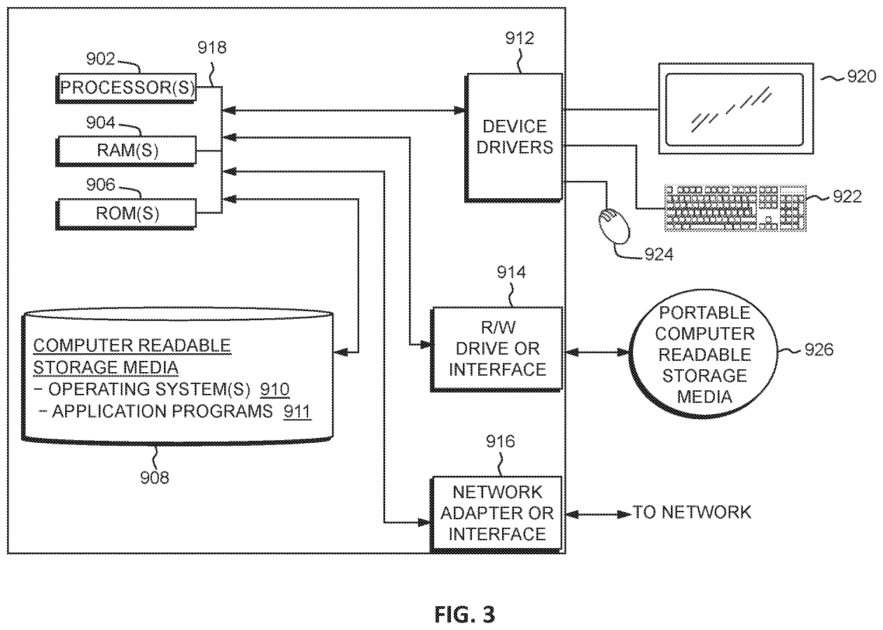

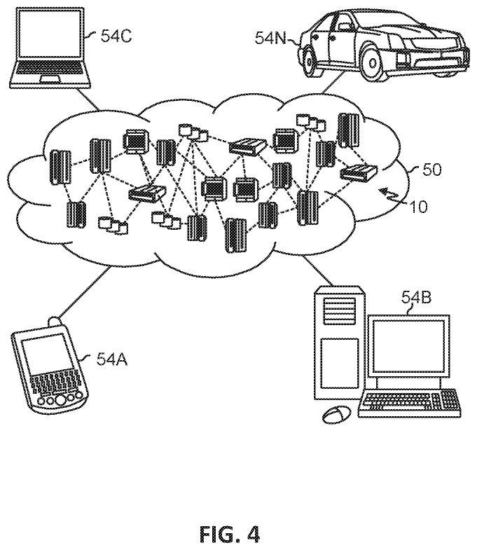

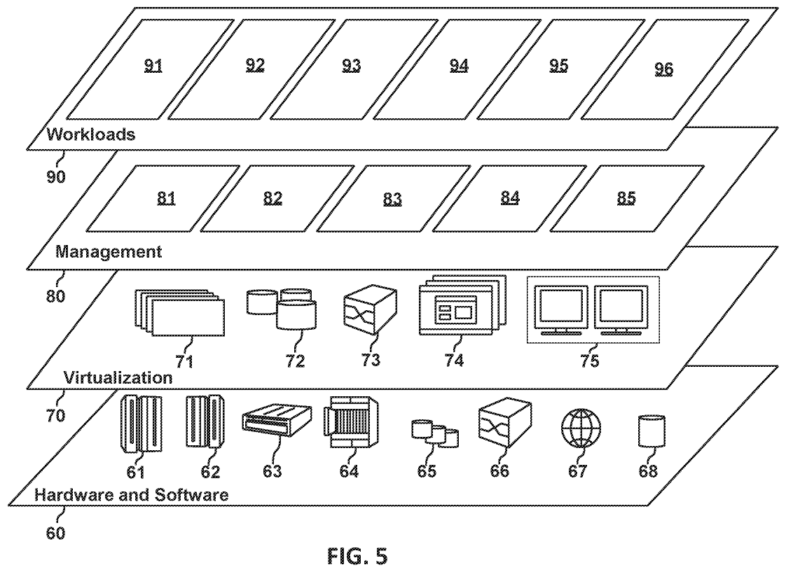

In the example embodiment, user computing device 110 contains user interface 112, internet of things (IoT) sensors 114, global positioning system (GPS) 116, and social media application 118. In various embodiments, user computing device 110 may be a laptop computer, tablet computer, netbook computer, personal computer (PC), a desktop computer, a personal digital assistant (PDA), a smart phone, or any programmable electronic device capable of communicating with social media server 120 and third party user computing device 140 via network 102. User computing device 110 may include internal and external hardware components, as depicted and described in further detail below with reference to FIG. 3. In other embodiments, user computing device 110 may be implemented in a cloud computing environment, as described in relation to FIGS. 4 and 5, herein. User computing device 110 may also have wireless connectivity capabilities allowing it to communicate with social media server 120, third party user computing device 140, and other computers or servers over network 102.

In an exemplary embodiment, user computing device 110 includes user interface 112, which may be a computer program that allows a user to interact with user computing device 110 and other connected devices via network 102. For example, user interface 112 may be a graphical user interface (GUI). In addition to comprising a computer program, user interface 112 may be connectively coupled to hardware components, such as those depicted in FIG. 3, for receiving user input. In an exemplary embodiment, user interface 112 is a web browser, however in other embodiments user interface 112 may be a different program capable of receiving user interaction and communicating with other devices.

In exemplary embodiments, IoT sensors 114 (and 114a) may include embedded computing systems that allow objects, such as third party user computing device 140, to be sensed remotely across existing network infrastructure, such as network 102, thus creating opportunities for more direct integration of the physical world into computer-based systems, and resulting in improved efficiency, accuracy, and economic benefit in addition to reduced human intervention. For example, IoT sensors 114 may be capable of detecting and tracking an authorized computing device of a friend (e.g., third party user computing device 140) within a social network, and within a given proximity of user computing device 110.

In various embodiments, IoT sensors 114 (and 114a) are embedded within various devices, such as third party user computing device 140, that contain a computer processing unit (CPU), memory, and power resource, and may be capable of communicating with user computing device 110 and social media server 120 over network 102.

In exemplary embodiments, third party user computing device 140 may refer to a wide variety of devices such as a smartphone, a mobile device, a smart watch, wearable devices that are individual-specific (e.g., heart monitoring devices, tailored clothing, hearing aid, etc.), kitchen appliances, or any other type of device that is capable of connecting with user computing device 110 over network 102.

User computing device 110 and third party user computing device 140 can collect useful data, such as location data and timestamp data of social media posts, with the help of various existing technologies (e.g., GPS 116) and then autonomously flow the data between other devices. In this fashion, IoT proximity information between user computing device 110 and third party user computing device 140 can assist in determining a user's participation in a group dynamic related to a social media post.

Device proximity is a known art, and it is known to one of ordinary skill in the art that each and every IoT device can communicate with each other and can identify proximity of the one or more IoT devices within a threshold distance.

In exemplary embodiments, users may configure their mobile or wearable device (e.g., user computing device 110 and third party user computing device 140) regarding what information may be shared/restricted with other IoT computing devices, and may elect to opt-in and opt-out of any information tracking and/or sharing at any time, after being given proper disclosure and consent.

In an exemplary embodiment, GPS 116 (and GPS 116a) is a computer program on user computing device 110 that provides time and location information for a user. Modern GPS systems operate on the concept of time and location. In modern GPS systems, four or more satellites broadcast a continuous signal detailing satellite identification information, time of transmission (TOT), and the precise location of the satellite at the time of transmission. When a GPS receiver picks up the signal, it determines the difference in time between the time of transmission (TOT) and the time of arrival (TOA). Based on the amount of time it took to receive the signals and the precise locations of the satellites when the signals were sent, GPS receivers are capable of determining the location where the signals were received. In an exemplary embodiment, GPS 116 is capable of providing real-time location detection of the user, and hence whether the user is participating in an event with one or more users (i.e., whether user computing device 110 has come within a threshold proximity of a friends' location).

In exemplary embodiments, social media application 118 may be a web browser, computer application, or other computer program on user computing device 110 that is capable of accessing third party social media website platforms (e.g., social media server 120) for the purpose of viewing, posting, checking-in, attending an online social media event, and so forth. Social media application 118, in exemplary embodiments, is capable of time-stamping a social media post of a user at the time of posting.

Social media application 118, in exemplary embodiments, may also be capable of accessing the location of the user, as well as the location of one or more third party user computing devices' 140 proximity location to user computing device 110. In this fashion, social media application 118 is further capable of time-stamping (dynamically) an arrival time, a departure time, a text posting, an uploaded image, and so forth.

In exemplary embodiments, users need to register their electronic devices (e.g., user computing device 110, third party user computing device 140, etc.) to their social media accounts and enable sharing of data with their social media contacts (e.g., friends, family) prior to proximity location tracking and information sharing goes into effect. The user may opt-in (or out) of proximity location tracking and information sharing of data at any time.

For example, social media application 118 on user computing device 110 can track a user's contacts' (i.e., friends) locations to determine if one or more contacts are within a threshold proximity to the user, whether they have been tagged by the user, etc.

In exemplary embodiments, a contact may be deemed to have participated in an event with the user (i.e., ate dinner together, exercised together, played golf together, etc.) if the contact is within a threshold proximity of user computing device 110 for a threshold period of time, together with analysis of biometric data of the one or more users.

For example, Tom and Frank go jogging. Tom posts on his social media application 118, “I just went jogging and had a great workout.” Based on the proximity of Frank (e.g., via IoT sensors 114), one of Tom's associated “friends” in his social media network, together with Frank's increased heart rate and application that tracks Frank's workout, Tom's post is automatically tagged with “Tom and Frank go jogging.”

In exemplary embodiments, a user has the ability to override automatic tagging, and/or opt-in or opt-out of proximity detections and sharing of social media data, at any time.

In an exemplary embodiment, social media server 120 includes social media website 122, user accounts database 124, and name and context tagging system 130, and may be a laptop computer, tablet computer, netbook computer, personal computer (PC), a desktop computer, a personal digital assistant (PDA), a smart phone, a server, or any programmable electronic device capable of communicating with user computing device 110, and third party user computing device 140 via network 102. While social media server 120 is shown as a single device, in other embodiments, social media server 120 may be comprised of a cluster or plurality of computing devices, working together or working separately.

In an exemplary embodiment, social media website 122 is a website capable of hosting social media content shared between registered users, including user profiles and social media posts. For example, social media website 122 is capable of receiving manually input status updates of a user, location of a user, posted images (i.e., photographs) and videos of a user, natural language text associated with a posted image, status update, and/or location of a user, streaming/live video, check-ins at airports, cities, train stations, restaurant/bar/stadium establishments, and so forth, from a user, which may include a timestamp and geographic location of social media posts.

In exemplary embodiments, social media website 122 is accessed via an internet browser, such as user interface 112 on user computing device 110. In other embodiments, however, social media website 122 may be accessed via other means, or may be a standalone program.

In various embodiments, social media website 122 may be a collection of files, including, but not limited to, for example, HTML files, CSS files, XML files, image files and JavaScript files. Social media website 122 can also include other resources such as audio files and video files. In an exemplary embodiment, social media website 122 may be a social media website such as Facebook® (Facebook is a registered trademark of Facebook, Inc.), Twitter® (Twitter is a registered trademark of Twitter, Inc.), LinkedIn® (LinkedIn is a registered trademark of LinkedIn Corporation), or Instagram® (Instagram is a registered trademark of Instagram, LLC).

In exemplary embodiments, user accounts database 124 may store user profiles, preferences, contacts, categories of contacts, posts (e.g., user pictures, videos, status updates, check-ins, and so forth), location history of the user, computing device(s) associated with the user account, whether the user has opted in (or out) of computing device proximity tracking, etc. For example, user John Smith may be stored as a data object containing the following information in user accounts database 124: <Smith, John; 242_friends; device123_prox_track_enabled; share_friends{White,Jack; Green,Pearl; Brown,Abe}>.

In exemplary embodiments, user accounts database 124 receives input from user computing device 110, social media application 118, and name and context tagging system 130.

In various embodiments, user accounts database 124 is capable of being stored on name and context tagging system 130, user computing device 110, or any other server connected to network 102, as a separate database.

In an exemplary embodiment, third party user computing device 140 contains IoT sensors 114a and GPS 116a. In various embodiments, third party user computing device 140 may be a laptop computer, tablet computer, netbook computer, personal computer (PC), a desktop computer, a personal digital assistant (PDA), a smart phone, or any programmable electronic device capable of communicating with user computing device 110 and social media server 120, via network 102. Third party user computing device 140 may include internal and external hardware components, as depicted and described in further detail below with reference to FIG. 3. In other embodiments, third party user computing device 140 may be implemented in a cloud computing environment, as described in relation to FIGS. 4 and 5, herein. Third party user computing device 140 may also have wireless connectivity capabilities allowing it to communicate with user computing device 110, social media server 120, and other computers or servers over network 102.

In exemplary embodiments, third party user computing device 140 may be a mobile, or wearable, device of one or more social media contacts (i.e., friends) that have authorized, at a minimum, sharing of geographic location and social media data with the user (e.g., user computing device 110). The advantage of sharing data between social media contacts allows for a user's contacts to be associated with a geographic location, event, destination, etc. of the user if they are in proximity of each other, and further allows for a user's contacts to be automatically tagged at specific events, within a hierarchy of events, depicted in one social media posting of the user.

With continued reference to FIG. 1, name and context tagging system 130 may be a computer program on social media server 120 that contains instruction sets, executable by a processor. The instruction sets may be described using a set of functional modules. Name and context tagging system 130 receives input from user computing device 110, social media server 120, and third party user computing device 140. In alternative embodiments, name and context tagging system 130 may be a computer application on a separate electronic device, such as user computing device 110.

With continued reference to FIG. 1, the functional modules of name and context tagging system 130 include identifying module 132, mapping module 134, generating module 136, and posting module 138.

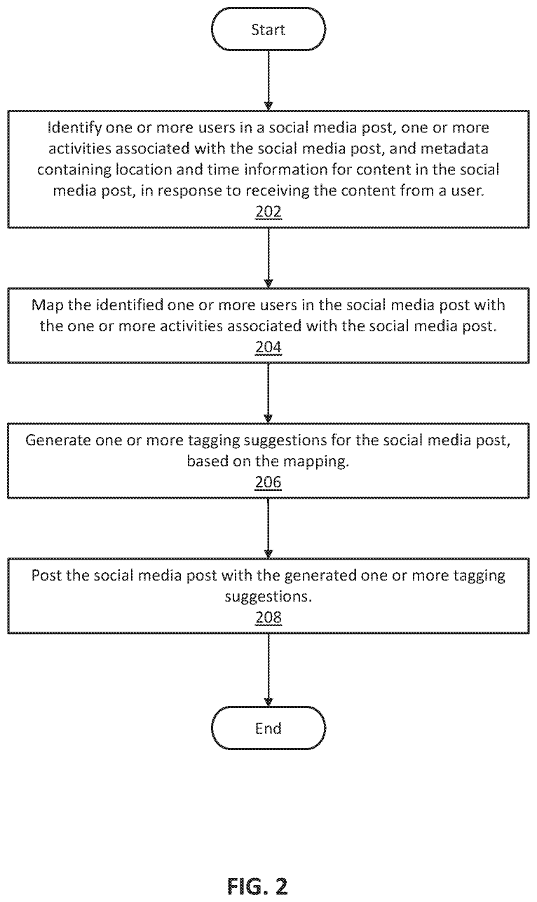

FIG. 2 is a flowchart illustrating the operation of name and context tagging system 130 of FIG. 1, in accordance with embodiments of the present invention.

With reference to FIGS. 1 and 2, identifying module 132 includes a set of programming instructions, in name and context tagging system 130, to identify one or more users in an electronic communication, one or more activities associated with the electronic communication, and metadata containing location and time information for content in the electronic communication, in response to receiving the content from a user (step 202). The set of programming instructions is executable by a processor.

In exemplary embodiments, identifying module 132 may use existing techniques, known to one of ordinary skill in the art, for identifying one or more users in an electronic communication. For example, image analysis and textual data analysis may be utilized to identify individual contacts, or “friends”.

Further, identifying module 132 is capable of identifying one or more activities associated with the electronic communication via image analysis and textual data analysis. For example, using textual data analysis, identifying module 132 can identify what activity is being performed, the purpose of the activity, any location and time mentioned in the text, etc.

In exemplary embodiments, identifying module 132 can identify metadata containing location and time information for the received content in the electronic communication by using at least one of the following in a group consisting of: natural language processing, image analysis, optical character recognition, text analysis algorithms, geographic location, and timestamp.

In exemplary embodiments, identifying module 132 may capture (i.e., receive) the geographic location of the user and the one or more users via GPS 116 on user computing device 110, or by any other means known to one of ordinary skill in the art.

In exemplary embodiments, identifying module 132 may capture (i.e., receive) the timestamp associated with an electronic communication of the user on social media application 118.

In exemplary embodiments, the electronic communication of the user includes at least one of the following: an image, a photo, a video, a text posting, an event, and a location.

In exemplary embodiments, identifying module 132 can identify the one or more activities performed by the identified one or more users in the electronic communication by correlating metadata extracted from the received content with biometric data of the identified one or more users. Biometrics is the technical term for body measurements and calculations and refers to metric related to human characteristics. Biometric data includes personal data resulting from specific technical processing relating to the physical, physiological, or behavioral characteristics of a natural person, which allow or confirm the unique identification of that natural person. Examples of biometric data include, but are not limited to, fingerprint, palm veins, face recognition, DNA, palm print, hand geometry, iris recognition, and odor. In exemplary embodiments, biometric data is tracked, together with mobile applications on a user's computing device (e.g., user computing device 110 and third party user computing device 140), in order to identify a context of the user (e.g., jogging, sleeping, etc.).

In alternative embodiments, identifying module 132 may be capable of identifying one or more users within a threshold proximity of the user via identified IoT sensors between one or more computing devices of the one or more users. In exemplary embodiments, users may configure their mobile or wearable device (e.g., user computing device 110 and third party user computing device 140) regarding what information may be shared/restricted with other IoT computing devices, and may elect to opt-in and opt-out of any information tracking and/or sharing at any time, after being given proper disclosure and consent.

In alternative embodiments, identifying module 132 may access an electronic calendar of a user (e.g., on user computing device 110) to identify location, time, and activity information of a user, and one or more additional users.

With reference to an illustrative example, three friends Mike, Sarbajit, and Jeremy go out to lunch. Jeremy takes a photograph at lunch and posts the image to his social media account. Identifying module 132 identifies the three individuals (Mike, Sarbajit, and Jeremy) via image analysis recognition and identification techniques known to one of ordinary skill in the art. After lunch, Mike and his wife drop off Sarbajit and Jeremy at the airport for their flight to Hawaii. Identifying module 132 determines that Sarbajit and Jeremy are traveling to Hawaii together based on their respective locations, determined via IoT sensors 114 and their electronic calendars. Sarbajit and Jeremy arrive in Hawaii and meet up with their friends Joe and Sam for dinner at the hotel. Identifying module 132 identifies Joe and Sam, as well as their dinner meetup at the hotel in Hawaii. In addition to the photo posted to his social media account, Jeremy posts a textual status update to his social media account letting his contacts know that he flew to Hawaii and met up with friends for dinner at the hotel.

With continued reference to FIGS. 1 and 2, mapping module 134 includes a set of programming instructions in name and context tagging system 130, to map the identified one or more users in the electronic communication with the one or more activities associated with the electronic communication (step 204). The set of programming instructions is executable by a processor.

In exemplary embodiments, mapping module 134 is capable of mapping the identified users in an electronic communication (e.g., social media post/image/video) with an associated activity in the electronic communication. In this fashion, mapping module 134 creates various segments of activities related to various identified individuals participating in the various created segments.

With continued reference to the illustrative example above, mapping module 134 maps the following identified individuals to an associated activity: Mike, Sarbajit, and Jeremy to their lunch meetup; Mike and his wife to dropping off Sarbajit and Jeremy at the airport; Sarbajit and Jeremy on a flight to Hawaii; Sarbajit, Jeremy, Joe, and Sam eating dinner together at the hotel in Hawaii.

With continued reference to FIGS. 1 and 2, generating module 136 includes a set of programming instructions in name and context tagging system 130, to generate one or more tagging suggestions for the electronic communication, based on the mapping (step 206). The set of programming instructions is executable by a processor.

In exemplary embodiments, the generated one or more tagging suggestions for the electronic communication may either relate to the names of the tagged individuals (e.g., nickname, professional name, etc.), and the context of the tagged individuals (e.g., eating lunch with the user, dropping off the user at the airport, traveling to Hawaii with the user, and so forth).

In exemplary embodiments, generating module 136 can associate one or more contextual relationships, in the electronic communication, for each of the identified one or more users engaged in the identified one or more activities with the user, and create one or more contextual categories, in the electronic communication, for each of the associated one or more contextual relationships.

In exemplary embodiments, the one or more contextual relationships are determined from at least one of, but not limited to, the following: a detected internet of things (IoT) device within a defined proximity of the user, calendar entries, social network feeds, textual analysis, and manual entries by the user.

In exemplary embodiments, generating module 136 is capable of tagging the identified one or more users, in the electronic communication, based on the identified one or more activities and the created one or more contextual categories, and displaying the tagged identified one or more users, in the electronic communication, in a hierarchical manner based on the created one or more contextual categories.

With continued reference to the illustrative example above, the various contextual categories related to Jeremy's social media post may include: lunch at ABC Restaurant, drop off at Airport, Flight to Hawaii, and dinner at Hawaii hotel. The identified users in Jeremy's social media post, together with the created contextual categories and participation of each identified user with each contextual category are displayed in a hierarchical fashion on social media website 122. This way, a user who views Jeremy's social media post can see that Mike, Sarbajit, Mike's wife, Joe, and Sam are tagged in various contextual categories within the post in order to reflect their respective participation. Otherwise, a third party viewer of Jeremy's post may believe that all tagged individuals traveled to Hawaii with Sarbajit and Jeremy, and met up with Joe and Sam for dinner at the Hawaii hotel.

In further embodiments, generating module is capable of tagging the one or more users identified in the electronic communication with an appropriate name that is selected from at least one of, but not limited to, the following: a nickname, an actual name, a professional name, and a group name.

In exemplary embodiments, displaying the appropriate name in the electronic communication is based on a status of a registered viewer of the electronic communication, and whether the user has agreed to share nicknames with other contacts in their social media account, for example. In exemplary embodiments, a user may elect to opt-in and opt-out of any information tracking and/or sharing at any time, after being given proper disclosure and consent.

For example, a user may tag a photo of himself with three friends. When the four friends are viewing the photo through their respective registered social media accounts, they will see themselves tagged with their nicknames (e.g., Mikey, Bobby, Dick, Larry). If a user outside of their “friends circle” (e.g., a colleague from work) sees the social media posting, they will see either the tagged individuals' actual names or professional name (e.g., Michael, Robert, Richard, Lawrence), depending on the configurations set up by the user.

With continued reference to the illustrative example above, Jeremy has his social media application 118 pre-configured to include Mike and Sarbajit in a category of “friends” called “Work Friends”. As a result, when Mike and Sarbajit are identified and tagged in a social media post by Jeremy, generating module 136 automatically assigns the tag “Work Friends”. Over time, name and context tagging system 130 has learned that Mike always refers to posts that include Mike, Sarbajit, and Jeremy as “Patent Circle Buds”, so generating module 136 additionally assigns that tag to posts that include Mike, Sarbajit, and Jeremy.

In alternative embodiments, name and context tagging system 130 may be capable of comparing the context category of a user's electronic communication to one or more calendars of the user (e.g., work or home), wherein the calendar's source (e.g., work or home) determines the tagging option for the identified user in the electronic communication (e.g., Mr. Garfinkel or Joey).

With continued reference to FIGS. 1 and 2, posting module 138 includes a set of programming instructions in name and context tagging system 130, to post the electronic communication with the generated one or more tagging suggestions (step 208). The set of programming instructions is executable by a processor.

In alternative embodiments, posting module 138 may automatically tag and post the electronic communication, together with the identified one or more users in a contextual category associated with the electronic communication of the user.

In alternative embodiments, name and context tagging system 130 can leverage contextual tagging to filter, or modify, social media posts of a user based on undesired consequences. For example, posting module 138 will not display name tags and/or social media posts of a user based on certain identified contextual categories or tags (e.g., drinking alcohol, etc.).

In further alternative embodiments, name and context tagging system 130 may create and leverage a corpus of images that could be used to identify social versus professional environments. One category of images (e.g., social) may be viewable to friends and family, while another category (e.g., professional) is not, and vice versa.

In alternative embodiments, name and context tagging system 130 may, in response to receiving content for a second electronic communication, identify an activity associated with the received content for the second electronic communication, and verify whether the identified one or more users associated with the created one or more contextual categories in the electronic communication are present in the second electronic communication. In response to verifying that the identified one or more users associated with the created one or more contextual categories in the electronic communication are present in the second electronic communication, name and context tagging system 130 may automatically tag each of the identified one or more users in the second electronic communication.

In exemplary embodiments, network 102 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 102 may include, for example, wired, wireless, or fiber optic connections which may be implemented as an intranet network, a local area network (LAN), a wide area network (WAN), or any combination thereof. In further embodiments, network 102 may be a Bluetooth network, a WiFi network, or a combination thereof. In general, network 102 can be any combination of connections and protocols that will support communications between user computing device 110, social media server 120, and third party user computing device 140.

FIG. 3 is a block diagram depicting components of a computing device (such as user computing device 110, social media server 120, and third party user computing device 140, as shown in FIG. 1), in accordance with embodiments of the present invention. It should be appreciated that FIG. 3 provides only an illustration of one implementation and does not imply any limitations with regard to the environments in which different embodiments may be implemented. Many modifications to the depicted environment may be made.

Computing device of FIG. 3 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as name and context tagging system 130, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device of FIG. 3 may also include a R/W drive or interface 914 to read from and write to one or more portable computer readable storage media 926. Application programs 911 on the computing device may be stored on one or more of the portable computer readable storage media 926, read via the respective R/W drive or interface 914 and loaded into the respective computer readable storage media 908.

Computing device of FIG. 3 may also include a network adapter or interface 916, such as a TCP/IP adapter card or wireless communication adapter (such as a 4G wireless communication adapter using OFDMA technology). Application programs 911 on the computing device may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Computing device of FIG. 3 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and controlling access to data objects 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present invention. Therefore, the present invention has been disclosed by way of example and not limitation.

1. A computer-implemented method comprising:
identifying one or more users in an electronic communication, one or more activities associated with the electronic communication, and metadata containing location and time information for content in the electronic communication, in response to receiving the content from a user;
mapping the identified one or more users in the electronic communication with the one or more activities associated with the electronic communication;
generating one or more tagging suggestions for the electronic communication, based on the mapping; and
posting the electronic communication with the generated one or more tagging suggestions.

2. The computer-implemented method of claim 1, wherein generating one or more tagging suggestions for the electronic communication further comprises:
identifying the one or more activities performed by the identified one or more users in the electronic communication by correlating metadata extracted from the received content with biometric data of the identified one or more users;
associating one or more contextual relationships, in the electronic communication, for each of the identified one or more users engaged in the identified one or more activities with the user; and
creating one or more contextual categories, in the electronic communication, for each of the associated one or more contextual relationships.

3. The computer-implemented method of claim 1, wherein identifying metadata containing location and time information for the received content comprises using at least one of the following in a group consisting of: natural language processing, image analysis, optical character recognition, text analysis algorithms, geographic location, and timestamp.

4. The computer-implemented method of claim 2, further comprising:
tagging the identified one or more users, in the electronic communication, based on the identified one or more activities and the created one or more contextual categories; and
displaying the tagged identified one or more users, in the electronic communication, in a hierarchical manner based on the created one or more contextual categories.

5. The computer-implemented method of claim 2, further comprising:
tagging the one or more users identified in the electronic communication with an appropriate name, selected from a group consisting of: a nickname, an actual name, a professional name, and a group name; and
displaying the appropriate name in the electronic communication, based on a status of a registered viewer of the electronic communication.

6. The computer-implemented method of claim 2, wherein the one or more contextual relationships are determined from at least one of the following in a group consisting of: a detected internet of things (IoT) device within a defined proximity of the user, calendar entries, social network feeds, textual analysis, and manual entries by the user.

7. The computer-implemented method of claim 1, further comprising:
in response to receiving content for a second electronic communication, identifying an activity associated with the received content for the second electronic communication;
verifying whether the identified one or more users associated with the created one or more contextual categories in the electronic communication are present in the second electronic communication; and
in response to verifying that the identified one or more users associated with the created one or more contextual categories in the electronic communication are present in the second electronic communication, automatically tagging each of the identified one or more users in the second electronic communication.

8. A computer program product for implementing a program that manages a device, comprising a non-transitory tangible storage device having program code embodied therewith, the program code executable by a processor of a computer to perform a method, the method comprising:
identifying one or more users in an electronic communication, one or more activities associated with the electronic communication, and metadata containing location and time information for content in the electronic communication, in response to receiving the content from a user;
mapping the identified one or more users in the electronic communication with the one or more activities associated with the electronic communication;
generating one or more tagging suggestions for the electronic communication, based on the mapping; and
posting the electronic communication with the generated one or more tagging suggestions.

9. The computer program product of claim 8, wherein generating one or more tagging suggestions for the electronic communication further comprises:
identifying the one or more activities performed by the identified one or more users in the electronic communication by correlating metadata extracted from the received content with biometric data of the identified one or more users;
associating one or more contextual relationships, in the electronic communication, for each of the identified one or more users engaged in the identified one or more activities with the user; and
creating one or more contextual categories, in the electronic communication, for each of the associated one or more contextual relationships.

10. The computer program product of claim 8, wherein identifying metadata containing location and time information for the received content comprises using at least one of the following in a group consisting of: natural language processing, image analysis, optical character recognition, text analysis algorithms, geographic location, and timestamp.

11. The computer program product of claim 9, further comprising:
tagging the identified one or more users, in the electronic communication, based on the identified one or more activities and the created one or more contextual categories; and
displaying the tagged identified one or more users, in the electronic communication, in a hierarchical manner based on the created one or more contextual categories.

12. The computer program product of claim 9, further comprising:
tagging the one or more users identified in the electronic communication with an appropriate name, selected from a group consisting of: a nickname, an actual name, a professional name, and a group name; and
displaying the appropriate name in the electronic communication, based on a status of a registered viewer of the electronic communication.

13. The computer program product of claim 9, wherein the one or more contextual relationships are determined from at least one of the following in a group consisting of: a detected internet of things (IoT) device within a defined proximity of the user, calendar entries, social network feeds, textual analysis, and manual entries by the user.

14. The computer program product of claim 8, further comprising:
in response to receiving content for a second electronic communication, identifying an activity associated with the received content for the second electronic communication;
verifying whether the identified one or more users associated with the created one or more contextual categories in the electronic communication are present in the second electronic communication; and
in response to verifying that the identified one or more users associated with the created one or more contextual categories in the electronic communication are present in the second electronic communication, automatically tagging each of the identified one or more users in the second electronic communication.

15. A computer system for implementing a program that manages a device, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
identifying one or more users in an electronic communication, one or more activities associated with the electronic communication, and metadata containing location and time information for content in the electronic communication, in response to receiving the content from a user;
mapping the identified one or more users in the electronic communication with the one or more activities associated with the electronic communication;
generating one or more tagging suggestions for the electronic communication, based on the mapping; and
posting the electronic communication with the generated one or more tagging suggestions.

16. The computer system of claim 15, wherein generating one or more tagging suggestions for the electronic communication further comprises:
identifying the one or more activities performed by the identified one or more users in the electronic communication by correlating metadata extracted from the received content with biometric data of the identified one or more users;
associating one or more contextual relationships, in the electronic communication, for each of the identified one or more users engaged in the identified one or more activities with the user; and
creating one or more contextual categories, in the electronic communication, for each of the associated one or more contextual relationships.

17. The computer system of claim 15, wherein identifying metadata containing location and time information for the received content comprises using at least one of the following in a group consisting of: natural language processing, image analysis, optical character recognition, text analysis algorithms, geographic location, and timestamp.

18. The computer system of claim 16, further comprising:
tagging the identified one or more users, in the electronic communication, based on the identified one or more activities and the created one or more contextual categories; and
displaying the tagged identified one or more users, in the electronic communication, in a hierarchical manner based on the created one or more contextual categories.

19. The computer system of claim 16, further comprising:
tagging the one or more users identified in the electronic communication with an appropriate name, selected from a group consisting of: a nickname, an actual name, a professional name, and a group name; and
displaying the appropriate name in the electronic communication, based on a status of a registered viewer of the electronic communication.

20. The computer system of claim 16, wherein the one or more contextual relationships are determined from at least one of the following in a group consisting of: a detected internet of things (IoT) device within a defined proximity of the user, calendar entries, social network feeds, textual analysis, and manual entries by the user.
